(19) United States
(12) Patent Application Publication
(10) Pub. No.: US 2005/0218543 A1
(43) Pub. Date: Oct. 6, 2005

(54) Method of controlling pore characteristics of porous structure

(75) Inventors: Muneyuki Iwabuchi, Nagoya-city (JP); Shinya Mori, Nagoya-city (JP); Shuuji Ueda, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., Nagoya-city (JP)

(21) Appl. No.: 11/082,972

(22) Filed: Mar. 18, 2005

(30) Foreign Application Priority Data
Mar. 31, 2004 (JP) 2004-107270

(51) Int. Cl. G01B 1/00

(52) U.S. Cl. 264/40.1; 210/739; 264/41; 264/630

(57) ABSTRACT

There is disclosed a method of controlling pore characteristics (porosity, average pore diameter, and total pore volume) of a porous structure, capable of manufacturing a porous structure having stable pore characteristics, even when fluctuation of a pore forming ratio of an materials to be used for extrusion differs with each lot. In the method of controlling the pore characteristics of the porous structure, a part of an materials to be used for extrusion of the porous structure is sampled and extruded, the pore characteristics of an obtained formed article or a characteristic of the materials to be used for extrusion are grasped beforehand, and the pore characteristics of the extruded/formed article and the fired article are controlled.

### BACKGROUND OF THE INVENTION

1. Field of the Invention

The present invention relates to a method of controlling pore characteristics of a porous structure after firing.

2. Description of the Related Art

A ceramic honeycomb structure has been widely used as a dust collecting filter for use in applications such as a pollution preventing environment countermeasure and product recovery from a high-temperature gas in various fields including chemical plants, electric power plants, iron and steel works, and disposal for industrial waste since it has a superior heat resistance and corrosion resistance. For example, a diesel particulate filter (DPF) for capturing particulates discharged from a diesel engine and the like are used on severe conditions such as high temperature and corrosive gas atmosphere, and therefore a ceramic honeycomb structure has been preferably used.

Especially in recent years, from a necessity of enhancing process capability of a dust collecting filter, there has been a demand for a porous structure having a low pressure loss, for example, a ceramic honeycomb structure having a high porosity. As a method of manufacturing a ceramic honeycomb structure (porous honeycomb structure) having the high porosity, a method of manufacturing a porous honeycomb filter has been proposed in which a mixture of a binder (organic binder such as methyl cellulose), a pore forming agent (organic material such as graphite) and the like, in addition to an aggregate particle material such as a cordierite forming material, and water, are kneaded to form a plastic material having plasticity, and the resultant is dried, and fired (see JP-A-2002-219319).

Moreover, a ceramic filter has been used in order to remove bacteria and particulates of waste contained in sewage or the like for purification. For example, a ceramic porous article is preferably used in a final step for purifying drinking water in a water purification plant. Thus, there has been a demand for a ceramic filter having a high porosity for enhancing a filtering amount even in the purification of the drinking water.

However, the degree of the fluctuation in a pore forming ratio of an materials to be used for extrusion varies, depending upon from lot to lot, and it has been difficult to obtain, as a final product, porous structures having stable pore characteristics (porosity, average pore diameter, and total pore volume) after firing.

### SUMMARY OF THE INVENTION

The present invention has been developed in view of the above-described conventional technical problems, and an object thereof is to provide a method of controlling pore characteristics (porosity, average pore diameter, and total pore volume) of a porous structure, capable of manufacturing a porous structure having stable pore characteristics after firing, even when the pore forming ratio of the fired extruded porous structures formed from a material for extrusion varies, depending upon from lot to lot.

Therefore, the present invention is to provide a method of controlling pore characteristics of a porous structure after firing to achieve the above-described objects.

[1] A method of controlling pore characteristics of a porous structure after firing, comprising the steps of: sampling a part of material for extruding a porous structure; extruding a porous structure using said sampled material to check pore characteristics of an obtained formed article and characteristics of material for extrusion to collect necessary data; and controlling pore characteristics of extruded/formed articles and fired articles based on the data collected.

[2] A method of controlling pore characteristics of a porous structure using a pore forming agent, comprising the steps of: sampling a part of a pore forming agent and a part of materials to be used for the extrusion of a porous structure; extruding a porous structure using said sampled materials to check pore characteristics of an obtained formed article and characteristics of the pore forming agent and the materials to be used for extrusion; adjusting an addition amount of the pore forming agent to be added to a clay containing the materials for extrusion based on obtained data; and controlling pore characteristics after firing of the extruded/formed article and the fired article.

[3] The method of controlling the pore characteristics of the porous structure according to [1] or [2], which further comprises a step of adjusting an addition amount of water with respect to amount of the materials for extrusion.

[4] The method of controlling the pore characteristics of the porous structure according to [2] or [3], wherein the pore forming agent is a combustible material.

[5] The method of controlling the pore characteristics of the porous structure according to any one of [2] to [4], wherein a part or all of the pore forming agent is a resin.

[6] The method of controlling the pore characteristics of the porous structure according to [5], wherein the resin is resin material containing a gas and/or a liquid therein.

[7] The method of controlling the pore characteristics of the porous structure according to [6], wherein the resin material containing the gas and/or the liquid is a foamable or foamed resin.

[8] The method of controlling the pore characteristics of the porous structure according to any one of [1] to [7], wherein the fired article is a porous honeycomb structure.

[9] The method of controlling the pore characteristics of the porous structure according to any one of [1] to [8], wherein sampling of a part of materials for extrusion and the extrusion using said sampled materials is carried out at every time when a lot of materials for extrusions is changed.

In the method of controlling the pore characteristics of the porous structure after firing of the present invention, even when characteristics as to the pore forming ratio of the materials for extrusion varies, depending upon lot to lot, a fired porous structure having stable pore characteristics can be manufactured.

### BRIEF DESCRIPTION OF THE DRAWINGS

FIG. 1 is a graph explaining how to control the pore characteristics (porosity) in the method of controlling pore characteristics of a porous honeycomb structure after firing in an embodiment according to the present invention.

### DESCRIPTION OF THE PREFERRED EMBODIMENT

An embodiment of a method of controlling pore characteristics of a fired porous structure according to the present invention will be described hereinafter in detail, but the present invention is not limited to this or interpreted as such, and can be variously changed, modified, and improved based on knowledge of a person skilled in the art without departing from the scope of the present invention.

In the method of controlling the pore characteristics of the porous structure according to the present invention, a part of materials to be used for the extrusion of the porous structure is sampled and extruded, the pore characteristics of an obtained formed article or a characteristic of the materials to be used for extrusion is checked beforehand, and the pore characteristics of the extruded/formed article and the fired article are controlled based on the obtained data.

Moreover, a method of controlling pore characteristics of a porous structure after firing according to the present invention is a method of controlling pore characteristics of a porous structure using a pore forming agent. In the method, a part of the pore forming agent and a part of an materials to be used for extrusion of the porous structure are sampled and a porous structure is extruded using the same; the pore characteristics of an obtained formed article and fluctuations of the materials to be used for extrusion are examined beforehand, and an addition amount of the pore forming agent to be added to the materials to be used for extrusion is adjusted based on the obtained data.

Consequently, in the present invention, even when the degree in the fluctuation of a pore forming ratio of the materials to be used for extrusion varies, depending upon lot to lot, a porous structure having stable pore characteristics after firing can be manufactured. Here, the term “lot” means each article of every forming material blend, every forming day, every drying day, and every firing, or for several blends, and several days, or a predetermined number of articles, for example, several to several tens of thousands of articles.

At this time, the pore forming agent for use in the present invention is preferably a combustible material. This is because the combustible material burns down to thereby form pores.

Examples of the pore forming agent having combustibility as described above include graphite having combustibility, flour, starch, phenol resin, polymethyl methacrylate, resin such as polyethylene and the like.

At this time, the resin for use in the present invention is preferably a resin material containing a gas and/or a liquid.

Here, the resin material containing the gas and/or the liquid is not especially limited, but is preferably a foamable resin material containing a polyethylene terephthalate gas, or a foamed resin of an acryl-based, methacrylate-based, or carboxylic acid-based microcapsule. Since the foamed resin is hollow, a high-porosity honeycomb filter can be obtained by a small amount of resin, and a high porosity can be obtained with a small material cost.

It is to be noted that as to the pore forming agent for use in the present invention, the above-described materials may be appropriately mixed and used.

Moreover, in the present invention, rotation conditions of a mixer/kneader, degree in vacuum of a kneader, extrusion speed, clay temperature, and addition amount of added water are adjusted at an extrusion time. Accordingly, conditions at a manufacturing time can be predicted, pore characteristics are further controlled, and the pore characteristics can be stabilized.

When the pore forming agent for use in the present invention is a combustible pore forming agent such as carbon, 2.0 to 20.0 parts by weight (more preferably 3.0 to 15.0 parts by weight) are preferably contained with respect to 100 parts by weight of a standard materials to be used for extrusion. When the pore forming agent is a gas-containing resin, 1.0 to 10.0 parts by weight (more preferably 1.0 to 5.0 parts by weight) are preferably contained. When the addition amount of the pore forming agent is small, a predetermined porosity is not obtained, and the performance of the resultant as a filter drops. When a large amount of pore forming agent is added, the porosity of the obtained filter is remarkably large, strength drops, and the filter is easily damaged while handled.

At this time, in the present invention, small-scaled extrusion is performed every change of each lot of materials to be used for extrusions, but a porous structure having stable pore characteristics can be preferably manufactured.

It is to be noted that the formed article by using a sampled materials obtained in the present invention should preferably have a shape close to that of an actual product as much as possible, thereby the data capable of assessing the evaluation as closer to the actual ones can be obtained.

Next, an application example of the method of controlling the pore characteristics of the porous structure after firing according to the present invention will be described.

To optimize the materials to be used for extrusion of the porous structure, as a raw material acceptance inspection (preceding small-sized test), a standard test (Test 1) is performed in which a standard material having a fixed addition amount of the pore forming agent and containing the pore forming agent is set beforehand and used for comparison in setting pore characteristics. Pore forming capability evaluation (Test 2) is performed to compare the addition amount of the pore forming agent with that of the standard test, and set the addition amount by comparison with the standard test.

(Test 1)

A standard pore forming agent whose pore forming capability is known is added to a standard material (e.g., main material from which cordierite by reaction firing is obtained) blended based on a reference blending table, thereafter the resultant material is extruded to form a porous structure, and pore characteristics are evaluated by using thus formed porous structure.

(Test 2)

A main material and a pore forming agent for obtaining cordierite by reaction firing for use in production are used, and extruded in the same manner as in (Test 1), pore characteristics are evaluated, and comparison with (Test 1) is performed.

Obtained results from Test 1 and Test 2 are compared, fluctuations of required pore characteristics (porosity, average pore diameter, and total pore volume) or materials to be used for extrusions are checked, and addition amounts of the pore forming agent and water to be added to the materials to be used for extrusion are determined. When the materials to be used for extrusion obtained through the above-described raw material acceptance inspection (preceding small-scaled test) is used, a porous structure having stable pore characteristics after firing can be manufactured.

### EXAMPLE

The present invention will be described hereinafter in more detail in accordance with an example how to control pore characteristics, especially the porosity (inner porosity) of a porous structure, but the present invention is not limited to the examples.

### EXAMPLE

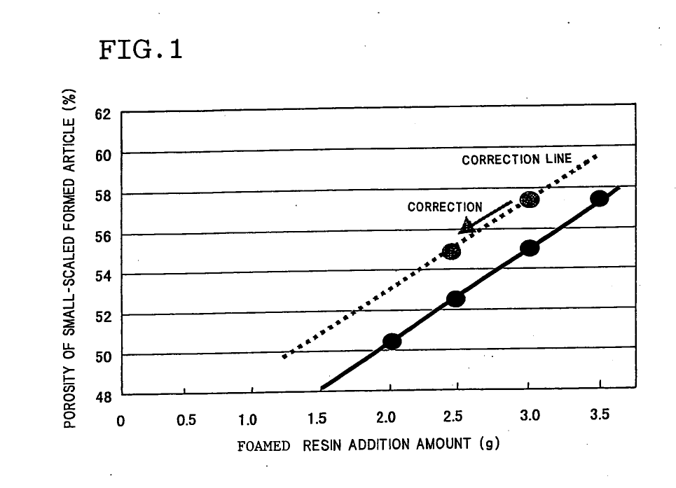

To accumulate the necessary data for controlling the porosity, a pore forming agent was added to the respective batches of clay in (Test 1), and the degree of the change in the porosity was tested. FIG. 1 shows data obtained in the testing production wherein 10 parts of carbon were added to 100 parts of main material, but with changing the addition amount of the foamable resin as shown in this FIGURE.

(Test 1)

A series of the porous structures was produced by using clay obtained by mixing materials formable cordierite by reaction firing in the actual production as a standard main material with 10 parts by weight of carbon and 3 parts by weight of foamable resin made of acrylic resin as a pore forming agent, 5 parts by weight of methyl cellulose as a binder for formation and 25 parts by weight of water. The clay was used to form a porous honeycomb structure having φ470 mm and a length of 100 mm, and 100 cells having width of 17 mills by using a small-sized mixer/kneader, kneader, and plunger. After drying the thus formed respective structures, the resultant structures were fired at 1200° C. to 1500° C., and then the porosity of each structure was measured by a mercury porosimeter. An obtained porosity was 55%.

(Test 2)

Carbon and foamable resin belonging to the lot for use of the actual production were added to materials capable of forming cordierite by reaction firing and belonging to the lot for use of the actual production, in the addition amounts and the production conditions similar to those of Test 1. As a result, a porosity of 57.5% was obtained.

One may conclude a guideline that a porosity same as that in standard (Test 1) would be attained by reducing the addition amount of the foamable resin by 0.5% from the data shown in FIG. 1.

A blend amount was set in the same manner as in (Test 1), the addition amount of the foamable resin was set to 2.5 parts, and production was performed. As a result, a porosity of 55% was similarly obtained.

As to a guideline of the addition amount shown in FIG. 1, the guideline of the porosity was prepared not only by the addition amount of the foamable resin but also by carbon and water addition amounts, forming conditions and the line, and (Test 2) was performed by comparison with (Test 1) using the standard material. Accordingly, it was confirmed that the control of the pore characteristics, such as porosity was possible.

According to a method of controlling pore characteristics of a porous structure of the present invention, even when characteristics of a pore forming ratio of materials to be used for extrusion varies, depending upon from lot to lot, a fired porous structure having stable pore characteristics can be manufactured.

1. A method of controlling pore characteristics of a fired porous structure, which comprises the steps of: sampling a part of material for extruding a porous structure; extruding a porous structure using said sampled material to check pore characteristics of an obtained formed article and characteristics of material for extrusion to collect necessary data; and controlling pore characteristics of extruded/formed articles and fired articles based on the data collected.

2. A method of controlling pore characteristics of a porous structure using a pore forming agent, which comprises the steps of sampling a part of a pore forming agent and a part of materials to be used for the extrusion of a porous structure; extruding a porous structure using said sampled materials to check pore characteristics of an obtained formed article and characteristics of the pore forming agent and the materials to be used for extrusion; adjusting an addition amount of the pore forming agent to be added to a clay containing the materials for extrusion based on obtained data; and controlling pore characteristics after firing of the extruded/formed article and the fired article.

3. The method of controlling the pore characteristics of the porous structure according to claim 1, which further comprises the step of adjusting the addition amount of water with respect to the materials to be used for extrusion.

4. The method of controlling the pore characteristics of the porous structure according to claim 2, which further comprises the step of adjusting the addition amount of water with respect to the materials to be used for extrusion.

5. The method of controlling the pore characteristics of the porous structure according to claim 2, wherein the pore forming agent is a combustible material.

6. The method of controlling the pore characteristics of the porous structure according to claim 2, wherein a part or all of the pore forming agent is a resin.

7. The method of controlling the pore characteristics of the porous structure according to claim 6, wherein the resin is a resin material containing a gas and/or a liquid.

8. The method of controlling the pore characteristics of the porous structure according to claim 7, wherein the resin material containing a gas and/or a liquid therein is a foamable or foamed resin.

9. The method of controlling the pore characteristics of the porous structure according to claim 1, wherein sampling of a part of materials for extrusion and the extrusion using said sampled materials is carried out at every time when a lot of materials for extrusions is changed.

10. The method of controlling the pore characteristics of the porous structure according to claim 2, wherein sampling of a part of materials for extrusion and the extrusion using said sampled materials is carried out at every time when a lot of materials for extrusions is changed.

11. The method of controlling the pore characteristics of the porous structure according to claim 1, wherein the fired article is a porous honeycomb structure.

12. The method of controlling the pore characteristics of the porous structure according to claim 2, wherein the fired article is a porous honeycomb structure.
